(19) United States
(12) Patent Application Publication
(10) Pub. No.: US 2020/0300518 A1
(43) Pub. Date: Sep. 24, 2020

(54) THERMAL EXPANSION VALVE FOR HVAC

(71) Applicant: DENSO International America, Inc., Southfield, MI (US)

(72) Inventor: Nicholas PETERS, Royal Oak, MI (US)

(21) Appl. No.: 16/359,516

(22) Filed: Mar. 20, 2019

(51) Int. Cl. F25B 41/06; F16K 47/04; F16K 49/00; F16K 31/56

(52) U.S. Cl. CPC F25B 41/062; F16K 47/04; F25B 2500/03; F16K 31/56; F25B 2500/12; F16K 49/00

(57) ABSTRACT

A thermal expansion valve (TXV) for a heating, ventilation, and air conditioning (HVAC) system. The TXV includes a first inlet chamber configured to receive refrigerant from a condenser of the HVAC system. The first inlet chamber includes a first portion and a second portion with an aperture therebetween that fluidly connects the first portion and the second portion together. The TXV also has a first outlet chamber through which the refrigerant from the condenser exits the TXV. Bubbles in the refrigerant rise due to buoyancy and are trapped by the partition in the first portion of the first inlet chamber to restrict the bubbles from passing through the TXV to an evaporator of the HVAC system until the bubbles shrink to a size smaller than the aperture.

### FIELD

The present disclosure relates to a thermal expansion valve (TXV) for a heating, ventilation, and air conditioning system (HVAC).

### BACKGROUND

This section provides background information related to the present disclosure, which is not necessarily prior art.

Heating, ventilation, and air conditioning (HVAC) systems typically include a thermal expansion valve (TXV), which controls the amount of refrigerant released into an evaporator. While current TXVs are suitable for their intended use, they are subject to improvement. For example, current TXVs fail to filter out bubbles in the sub-cooled refrigerant. Such bubbles often cause TXV hiss noise, which can be annoying to occupants of a vehicle that the HVAC system is installed in. To reduce the hiss noise, butyl rubber has been used to weigh down the TXV, however, the use of butyl rubber is undesirable because it adds significant costs to the HVAC system. An improved TXV that is able to reduce the hiss noise without using butyl rubber would therefore be desirable. The present disclosure advantageously includes an improved TXV that reduces TXV hiss noise without the use of butyl rubber. The present disclosure provides numerous other advantages and unexpected results as well, as explained in detail herein and as one skilled in the art will appreciate.

### SUMMARY

This section provides a general summary of the disclosure, and is not a comprehensive disclosure of its full scope or all of its features.

The present disclosure includes a thermal expansion valve (TXV) for a heating, ventilation, and air conditioning (HVAC) system. The TXV includes a first inlet chamber configured to receive refrigerant from a condenser of the HVAC system. The first inlet chamber includes a first portion and a second portion with an aperture therebetween that fluidly connects the first portion and the second portion together. The TXV also has a first outlet chamber through which the refrigerant from the condenser exits the TXV. Bubbles in the refrigerant rise due to buoyancy and are trapped in the first portion of the first inlet chamber with the help of the aperture. This restricts bubbles from flowing to the first outlet chamber and passing through the TXV until bubble size is smaller than aperture opening.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 illustrates an exemplary HVAC system including a TXV in accordance with the present disclosure; and

FIG. 2 is a cross-sectional view of the TXV of FIG. 1.

Corresponding reference numerals indicate corresponding parts throughout the several views of the drawings.

### DETAILED DESCRIPTION

Example embodiments will now be described more fully with reference to the accompanying drawings.

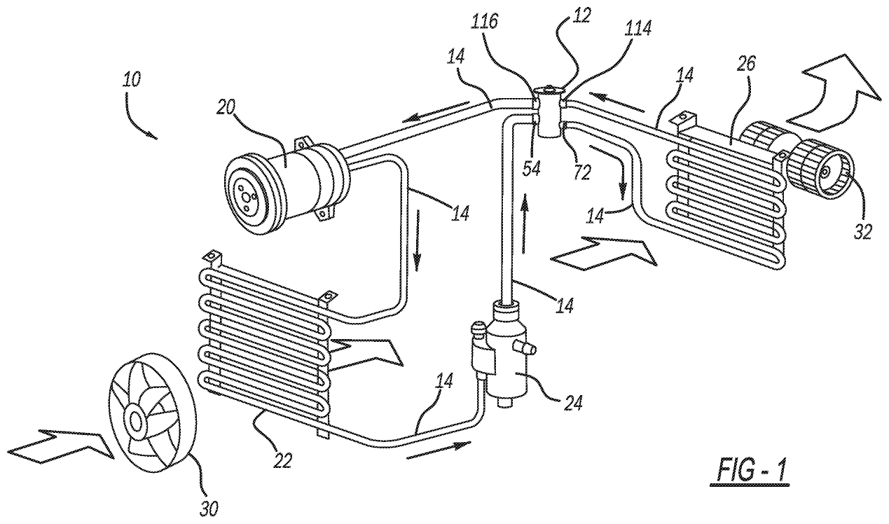

FIG. 1 illustrates an exemplary heating, ventilation, and air conditioning (HVAC) system 10. The HVAC system 10 may be any suitable HVAC system, such as any suitable vehicle HVAC system. The HVAC system 10 may be configured for use in any suitable vehicle, such as any suitable passenger vehicle, sport utility vehicle, recreational vehicle, mass transit vehicle, military vehicle/equipment, construction vehicle/equipment, watercraft, aircraft, etc. The HVAC system 10 may also be any suitable non-vehicular HVAC system, such as a building HVAC system.

The HVAC system 10 includes a thermal expansion valve (TXV) 12 in accordance with the present disclosure. The TXV 12 is connected to various refrigerant conduits 14, which deliver any suitable refrigerant to and from the TXV 12 from various other components of the HVAC system 10. The other components of the HVAC system 10 include a compressor 20, which compresses the refrigerant into a highly pressurized gas. The highly pressurized gas is directed through a condenser 22, where the refrigerant condenses into a highly pressurized liquid and radiates heat. From the condenser 22, the refrigerant flows through a dryer 24, which removes excess water from the refrigerant. From the dryer 24, the refrigerant flows through the TXV 12. The refrigerant enters the TXV 12 as a highly pressurized subcooled liquid, and exits the TXV 12 as a lower pressure vapor/liquid mixture. The lower pressure refrigerant flows through an evaporator 26, where the refrigerant absorbs heat to cool the surrounding environment, such as a vehicle passenger cabin. The refrigerant exits the evaporator 26 as a super-heated vapor, and flows through the TXV 12 back to the compressor 20. The HVAC system 10 further includes a fan 30, which generates airflow across the condenser 22 to facilitate radiation of heat from the refrigerant flowing through the condenser 22. A blower 32 generates airflow across the evaporator 26 to facilitate heat absorption.

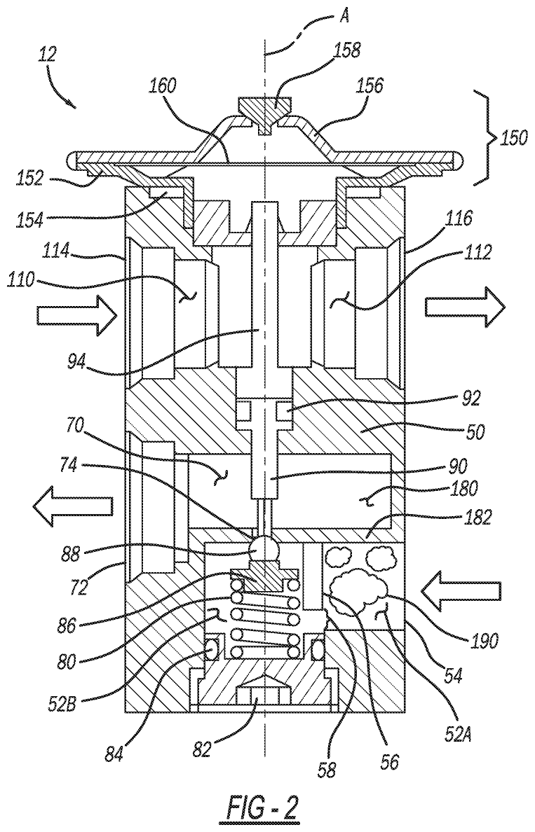

With continued reference to FIG. 1, and additional reference to FIG. 2, the TXV 12 will now be described in additional detail. The TXV 12 includes a body 50 defining a first inlet chamber, which has a first portion 52A and a second portion 52B. A first inlet opening 54 of the first portion 52A is connected to the refrigerant conduit 14 for the delivery of the sub-cooled liquid refrigerant from the condenser 22 into the first inlet chamber. A partition 56 divides the first inlet chamber into the first portion 52A and the second portion 52B. The partition 56 defines an aperture 58 between the partition 56 and the body 50. In the example illustrated, the partition 56 extends generally parallel to a longitudinal axis A of the TXV 12. The aperture 58 is sized to prevent bubbles 190 present in the refrigerant from flowing freely through the aperture 58 when the bubbles 190 are larger than the aperture 58.

The TXV 12 further includes a first outlet chamber 70 having a first outlet opening 72. The first outlet opening 72 is connected to a refrigerant conduit 14 for transporting refrigerant from the TXV 12 to the evaporator 26. The body 50 further defines an orifice 74 between the second portion 52B of the first inlet chamber and the first outlet chamber 70 to allow refrigerant to flow from the second portion 52B of the first inlet chamber to the first outlet chamber 70.

Seated within the second portion 52B of the first inlet chamber is a spring 80. The spring 80 sits on an adjusting nut 82. Between the adjusting nut 82 and the body 50 is an 0-ring 84. Seated on the spring 80 is a carrier 86. A stopper or ball 88 is supported by the carrier 86 in the orifice 74 to close the orifice 74 and prevent refrigerant from flowing from the second portion 52B of the first inlet chamber into the first outlet chamber 70. The stopper 88 is seated at an end of a push rod 90. Extending about the push rod 90 is an 0-ring 92. The push rod 90 abuts a stem 94, which extends to a power assembly 150. The power assembly 150 actuates the stem 94 and the push rod 90 to move the stopper 88 out from within the orifice 74 to open the orifice 74 and allow refrigerant to flow through the orifice 74 from the second portion 52B of the first inlet chamber into the first outlet chamber 70. The power assembly 150 will be described further herein.

The body 50 of the TXV 12 further defines a second inlet chamber 110 and a second outlet chamber 112. The second inlet chamber 110 has a second inlet opening 114, and the second outlet chamber 112 has a second outlet opening 116. The refrigerant conduit 14 is connected to the second inlet opening to deliver super-heated vapor refrigerant from the evaporator 26 into the second inlet chamber 110. The super-heated vapor refrigerant flows through the second inlet chamber 110 and into the second outlet chamber 112, which is connected to, and in fluid communication with, the second inlet chamber 110. The super-heated vapor refrigerant flows from the second outlet chamber 112 out through the second outlet 116, and through the refrigerant conduit 14 to the compressor 20.

The power assembly 150 includes a cup 152, which is seated on a gasket 154. Seated on the cup 152 is a lid 156. Extending through the lid 156 is a plug 158. The plug 158 is arranged at a center of the lid 156 along the longitudinal axis A. The power assembly 150 further includes a diaphragm 160, which is movable to actuate the stem 94 and the push rod 90 to move the stopper 88 out from within the orifice 74 to open the orifice 74.

The power assembly 150 is filled with refrigerant gas, often referred to in the art as “operation gas.” This operation gas is heated by the refrigerant flowing through the second inlet chamber 110 and the second outlet chamber 112 from the evaporator 26. The position of the stopper (or ball) 88 is determined by the pressure difference between, above, and below the diaphragm 160, the spring force of the spring 80, and the pressure difference before and after the spring 80.

The spring 80 is located between the adjusting nut 82 and the carrier 86. The spring 80 is used to provide tension necessary to seat the stopper 88 under no load conditions. Adjusting the nut 82 changes the tension of the spring 80, and is used to set the super-heat valve setting. The amount of refrigerant metering through the TXV 12 is based on a balance between the force of the spring 80 and the pressure of the operation gas within the power assembly 150.

When refrigerant flows through the second inlet chamber 110 and the second outlet chamber 112, a pressure difference occurs and the diaphragm 160 is displaced based on that difference. The diaphragm 160 is connected to the stem 94 and the push rod 90, which pushes against the spring 80, and moves the stopper 88 out from within the orifice 74. Thus, as the diaphragm 160 is displaced, the orifice 74 opens to various degrees based on the displacement of the diaphragm 160. The degree to which the orifice 74 is opened determines the volume of refrigerant that flows through the TXV 12 to the evaporator 26.

The TXV 12 further includes a conduction cavity 180. The conduction cavity 180 is in fluid communication with the first outlet chamber 70. The conduction cavity 180 and the first outlet chamber 70 are on opposite sides of the push rod 90 and the stopper 88. Together, the conduction cavity 180 and the first outlet chamber 70 provide a single cavity that extends across the push rod 90.

Between the conduction cavity 180 and the first portion 52A of the first inlet chamber is a conduction wall 182. The conduction wall 182 is a portion of the body 50 between the conduction cavity 180 and the first portion 52A. The relatively low-pressure refrigerant present in the conduction cavity 180 is cooler than the relatively high-pressure refrigerant present in the first portion 52A of the first inlet chamber. Through the process of conduction, the cooler refrigerant in the conduction cavity 180 cools the refrigerant at the first portion 52A, and cools the bubbles 190 present in the first portion 52A. Cooling the bubbles 190 present in the first portion 52A advantageously reduces the size of the bubbles 190 prior to the bubbles 190 reaching the evaporator 26. Reducing the size of the bubbles 190 advantageously reduces the TXV hiss noise. Thus the present disclosure advantageously reduces the TXV hiss noise without the need for using relatively expensive butyl rubber to weight down the TXV valve, as is done with various existing TXVs. One skilled in the art will appreciate that the present disclosure provides numerous additional advantages as well and various unexpected results.

The TXV 12 converts subcooled liquid refrigerant into low-temperature/low-pressure, two-phase vapor/liquid mixture by throttling the refrigerant flow. The vapor/liquid mixture then travels through the evaporator 26, where the low-temperature/low-pressure refrigerant absorbs heat from a passenger cabin, for example, as the remaining liquid refrigerant evaporates inside the evaporator 26 to provide cooling. The low-pressure, super-heated vapor refrigerant travels to the compressor 20 and is compressed to a high-pressure/high-temperature super-heated vapor. The high-temperature/high-pressure vapor from the compressor 20 is condensed into a liquid in the condenser 22 using outside air. The refrigerant is then directed back to the TXV 12 and enters the TXV 12 as a subcooled liquid where the loop begins again.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A thermal expansion valve (TXV) for a heating, ventilation, and air conditioning (HVAC) system, the TXV comprising:
a first inlet chamber configured to receive refrigerant from a condenser of the HVAC system;
a first outlet chamber through which the refrigerant from the condenser exits the TXV; and
a partition within the first inlet chamber defining an aperture between a first portion and a second portion of the first inlet chamber such that bubbles in the refrigerant rise due to buoyancy and are trapped by the partition in the first portion of the first inlet chamber to restrict the bubbles from passing through the TXV to an evaporator of the HVAC system until the bubbles shrink to a size smaller than the aperture.

2. The TXV of claim 1, further comprising an orifice defined by a body of the TXV between the second portion of the first inlet chamber and the first outlet chamber to provide fluid communication between the first inlet chamber and the first outlet chamber.

3. The TXV of claim 2, further comprising a stopper movable into and out of the orifice to control flow of refrigerant therethrough.

4. The TXV of claim 1, further comprising a conduction cavity in fluid communication with the first outlet chamber.

5. The TXV of claim 4, wherein:
the conduction cavity is opposite to the first portion of the first inlet chamber;
a conduction wall separates the conduction cavity from the first portion of the first inlet chamber; and
bubbles trapped in the first portion of the first inlet chamber are cooled and reduced in size by conduction using expanded refrigerant.

6. The TXV of claim 5, wherein the first outlet chamber and the conduction cavity are a single cavity that extends across a push rod that actuates the stopper.

7. The TXV of claim 1, wherein the second portion of the first inlet chamber includes a spring that biases a stopper of the TXV in a closed position.

8. The TXV of claim 1, wherein the first inlet chamber and the first outlet chamber are on opposite sides of a stopper that regulates refrigerant flow through the TXV.

9. The TXV of claim 8, wherein the first inlet chamber is vertically offset from the first outlet chamber.

10. The TXV of claim 1, wherein the partition divides the first inlet chamber into the first portion and the second portion.

11. The TXV of claim 1, further comprising a second inlet chamber and a second outlet chamber that are aligned with one another and in fluid communication with one another;
wherein the second inlet chamber and the second outlet chamber are between a power assembly of the TXV and the first outlet chamber.

12. The TXV of claim 1, wherein the partition extends vertically more than half way across the first inlet chamber.

13. The TXV of claim 1, wherein the partition extends parallel to a longitudinal axis of the TXV.

14. The TXV of claim 1, further comprising an orifice that fluidly connects the first inlet chamber to the first outlet chamber;
wherein the partition is within the first inlet chamber between the orifice and a first inlet opening of the first inlet chamber.

15. A thermal expansion valve (TXV) for a heating, ventilation, and air conditioning (HVAC) system, the TXV comprising:
a first inlet chamber configured to receive refrigerant from a condenser of the HVAC system, the first inlet chamber includes a first portion and a second portion with an aperture therebetween that fluidly connects the first portion and the second portion together;
a first outlet chamber through which the refrigerant from the condenser exits the TXV;
a conduction cavity in fluid communication with the first outlet chamber;
a conduction wall separating the conduction cavity from the first portion of the first inlet chamber;
wherein:
bubbles trapped in the first portion of the first inlet chamber are cooled and reduced in size by conduction when expanded refrigerant is present in the conduction cavity; and
bubbles in the refrigerant that rise due to buoyancy and are larger than the aperture are trapped in the first portion of the first inlet chamber and restricted from flowing to the first outlet chamber and passing through the TXV.

16. The TXV of claim 15, wherein the aperture is at least partially defined by a partition wall within the first inlet chamber, the bubbles that rise due to buoyancy are trapped by the partition in the first portion of the first inlet chamber to restrict the bubbles from passing through the TXV to an evaporator of the HVAC system until the bubbles shrink to a size smaller than the aperture.

17. The TXV of claim 16, further comprising an orifice that fluidly connects the first inlet chamber to the first outlet chamber;
wherein the partition is within the first inlet chamber between the orifice and a first inlet opening of the first inlet chamber.

18. The TXV of claim 17, further comprising a stopper movable into and out of the orifice to control flow of refrigerant therethrough.

19. The TXV of claim 15, wherein the first outlet chamber and the conduction cavity are a single cavity through which extends a push rod that actuates a stopper movable into and out of an orifice that fluidly connects the first inlet chamber to the first outlet chamber to control flow of refrigerant through the orifice.

20. The TXV of claim 15, wherein the conduction wall is a portion of a body of the TXV between the first portion of the first inlet chamber and the conduction cavity.
